(19) United States
(12) Patent Application Publication
(10) Pub. No.: US 2003/0056091 A1
(43) Pub. Date: Mar. 20, 2003

(54) Method of scheduling in a reconfigurable hardware architecture with multiple hardware configurations

(76) Inventor: Craig B. Greenberg, Sunnyvale, CA (US)

Correspondence Address: Robert E. Krebs, Thelen Reid & Priest LLP, P.O. Box 640640, San Jose, CA, 95164-0640, US

(21) Appl. No.: 09/953,568

(22) Filed: Sep. 14, 2001

(51) Int. Cl. G06F 9/24

(52) U.S. Cl. 713/100

(57) ABSTRACT

A scheduler for a reconfigurable chip is described in which multiple configurations for single function are stored. The scheduler has the option of selecting any one of the configurations. The system increase the efficiency of the reconfiguration chips operation.

### BACKGROUND OF THE INVENTION

The present invention relates to reconfigurable chips which can be used to implement an algorithm.

One software element that is useful for a reconfigurable chip is a scheduler. A scheduler interprets the sections of a program and schedules functions to be loaded into different resources of the reconfigurable chip. In one embodiment, the function is optimized for reconfigurable chip usage and the scheduler determines where to load this configuration of a function.

It is desired to have an improved scheduler for use with a reconfigurable chip.

### SUMMARY OF THE INVENTION

One embodiment of the present invention comprises using multiple possible configurations for implementing a specific function on a reconfigurable chip. Rather than a single optimized implementation of a function, multiple configurations, each having different time and resource requirements, are determined. The scheduler can choose one of these configurations to be loaded onto the reconfigurable chip based upon the time and resource requirements of the configurations and available time slots and resources on the reconfigurable chip.

The available resources of a reconfigurable chip at any time is variable. For example, in some cases, it is desirable to use configurations that use a large amount of resources but do not use these resources for a relatively long time. In other instances, it is more useful to employ a configuration that uses fewer resources but takes a longer time.

By having access to these multiple configurations, the scheduler can assign functions to the reconfigurable chip in a more efficient manner, speeding up the operation of the chip since few of the resources are left unused at any time.

The system of the present invention preferably uses indications giving information about the time and resource requirements of the configurations and a schedule of time slots and resources. The schedule fits one of the configurations into the schedule based upon the indications of the time and resource requirements of the configurations.

The scheduler can be a dynamic scheduler operating at runtime which changes based upon the operations of the program, or it can be a static scheduler produced during compilation.

In one embodiment, the invention comprises a scheduler for a reconfigurable chip. The scheduler is adapted to select a configuration from a group of more than one configurations. Each of the configurations is adapted to implement the same function on a reconfigurable chip, the configurations having different time and resource requirements, wherein the scheduler uses an indication of a schedule of available resources and the time and resource requirements of the configuration to select the configuration to be loaded on the reconfigurable chip.

### BRIEF DESCRIPTION OF THE DRAWING FIGURES

FIG. 1 is a drawing of a reconfigurable chip.

FIGS. 2A and 2B illustrate the resources and time required by two different configurations for a function to be implemented a reconfigurable chip.

FIGS. 3A and 3B illustrate schedules implementing five runs of the function of FIG. 2A or FIG. 2B, respectively.

FIG. 4 illustrates a schedule that allows the use of the configuration of FIG. 2A or the configuration of FIG. 2B.

FIG. 5 is a flow chart illustrating a method of one embodiment of the present invention.

FIG. 6 is a chart illustrating the operation of one embodiment of the scheduler of the present invention.

FIG. 7 is a diagram of a schedule for the example of FIG. 6.

### DETAILED DESCRIPTION OF THE INVENTION

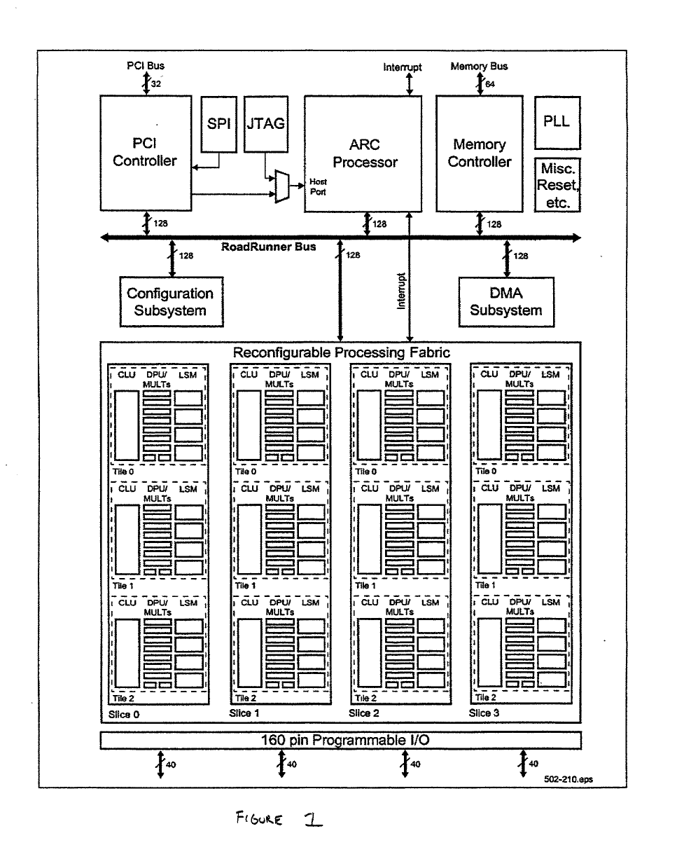

FIG. 1 is a diagram of a reconfigurable chip 20. The reconfigurable chip 20 includes a number of slices 32, 34, 36, 38, the slices including reconfigurable logic and memory units. The reconfigurable logic preferably divided into reconfigurable logic blocks able to implement a number of different functions. The reconfigurable logic blocks preferably include an arithmetic logic unit (ALU). The slices have associated configuration memory. The configuration memory stores the different configurations for the slices.

The term “configuration” has two different possible meanings for the present invention. It can mean the configuration of the reconfigurable logic at any time, but it can also mean, for a given function, the set of configurations over time needed to implement a function.

In one embodiment, configurations are loaded through a configuration buffer and an interface onto the system data bus and system address bus. The configurations are stored in an external memory and loaded through the memory controller. The reconfigurable chip also includes a CPU such as an ARC processor. The CPU runs sections of an algorithm that cannot be effectively run on the reconfigurable fabric. The CPU also in a dynamic scheduling environment preferably runs a scheduler.

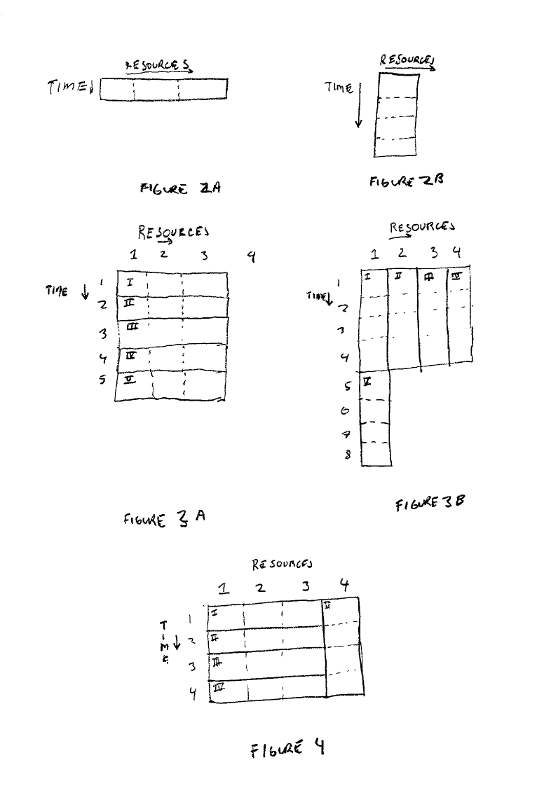

FIG. 2A illustrates an example of one configuration that can be produced for a given function. This example uses three resources but takes one time block. FIG. 2B illustrates another configuration. This configuration uses one resource but takes four time blocks. The resources could be, for example, the entire reconfigurable slice, or it could be some more detailed level of the resources on a reconfigurable chip. Note that the number of resource time blocks can be different for the different embodiments. For example, the embodiment of FIG. 2B uses more resource time blocks than the embodiment of FIG. 2A. Prior art would likely select schedulers the configuration of FIG. 2A as the optimal configuration.

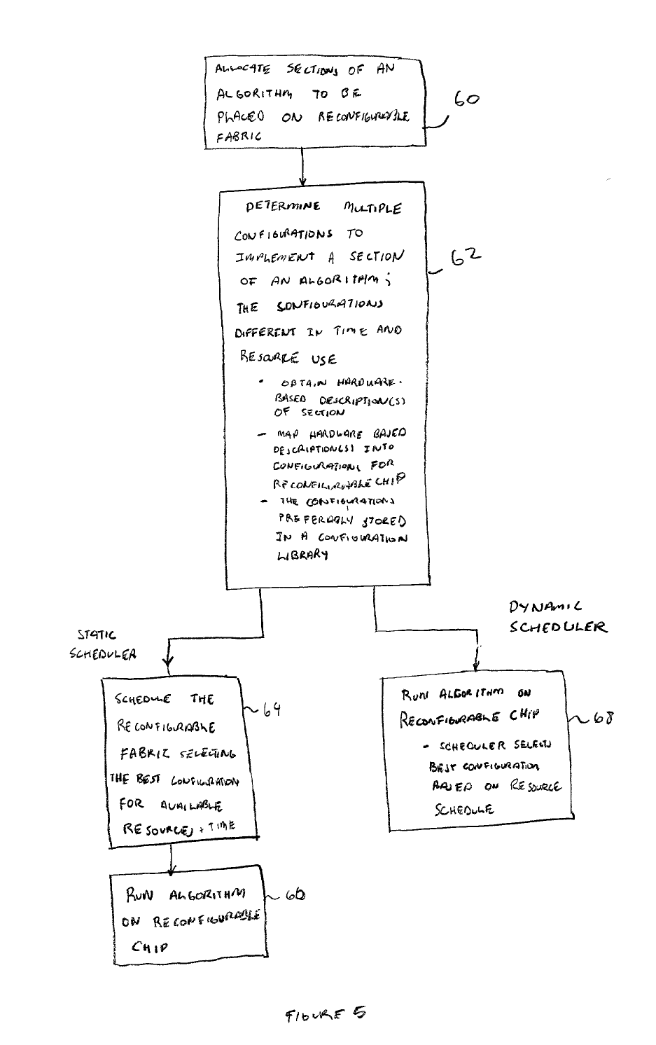

FIG. 3A illustrates a system in which five of the configurations of FIG. 2A are loaded into a reconfigurable chip. This takes five time periods and leaves the resource labeled four unused.

FIG. 3B illustrates a system in which the configuration of FIG. 2B is used exclusively. In this example, it takes eight time periods for the last function to be complete.

FIG. 4 illustrates a system in which the scheduler can select between two different configurations, the configurations of FIGS. 2A and 2B, for scheduling the reconfigurable chip. In this example, functions 1, 2, 3, 4 are implemented using the configuration of FIG. 2A, and configuration 5 is implemented by the example of FIG. 2B.

This finishes all five functions within four time periods. Note that the schedule of FIG. 4 is more advantageous than either of the schedules of FIGS. 3A or 3B. Even though the configuration of FIG. 2B uses more resource time blocks than the configuration of FIG. 2A, In this example, the ability to use the configuration of FIG. 2B improves the efficiency of the reconfigurable chip.

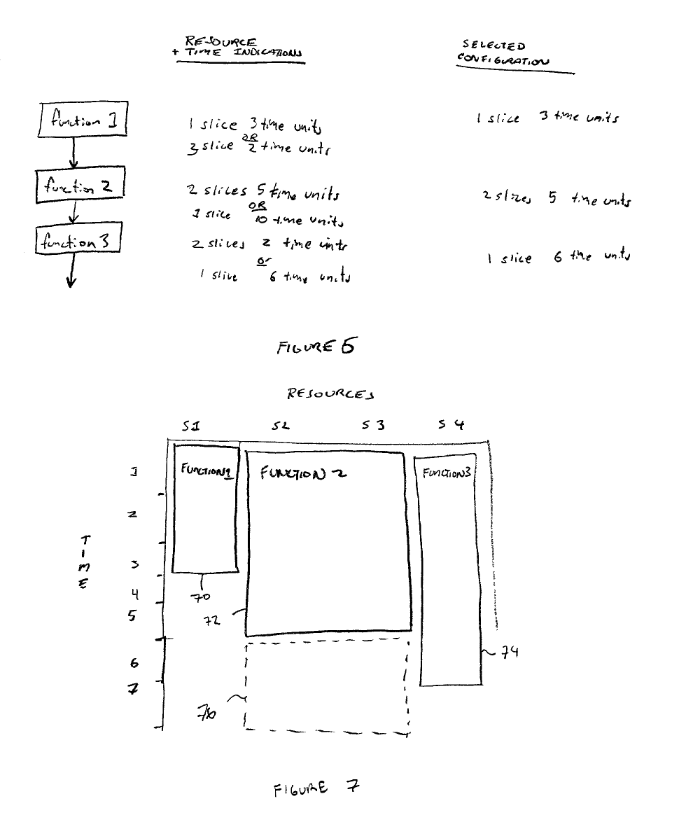

FIG. 5 illustrates a method of the present invention. In this example, sections of an algorithm are allocated to be placed upon a reconfigurable fabric. In one embodiment, a computer program, such as a program written in a high-level language like C, divided into sections to be loaded upon the reconfigurable chip. This can be done manually or with the use of a computer program. In step 62, multiple configurations to implement a section of the algorithm are determined, the configurations being different in time and resource use. In one embodiment, hardware-based descriptions of the section of the algorithm are produced. The hardware-based descriptions are mapped into the configurations for the reconfigurable chip. The configurations are preferably stored in a configuration library.

There are two different main types of schedulers that can use the system of the present invention. A static scheduler operates before the algorithm is run and cannot take into consideration data generated by the algorithm. A dynamic scheduler operates at runtime and can take into consideration the data generated by the algorithm. In the static scheduler of step 64, the reconfigurable fabric is scheduled, selecting the best configuration for the available resources and time. In step 66, the algorithm is run on the reconfigurable chip. For the dynamic scheduler, in step 68 the algorithm is run on the reconfigurable chip and the scheduler selects the best configuration out of the group of configurations based on the resource availability.

FIGS. 6 and 7 illustrate a further embodiment of the system of the present invention. FIG. 7 illustrates a schedule for the example of FIG. 6. In this example, functions 1, 2 and 3 need to be implemented. Each of these functions are associated with multiple configurations having different time and resource values. Function 1 can be implemented using a one-slice, three-time-unit configuration, or a three-slice, two-time-unit configuration. Function 2 can be implemented using a two-slice, five-time-unit configuration, or one-slice, ten-time-unit configuration. Function 3 can be implemented using a two-slice, two-time-unit configuration, or a one-slice, six-time-unit configuration.

In this example, Function 1 is implemented using the one slice, three time units configuration; and Function 2 is implemented using the two slices, five time units configuration. This leaves Function 3 with a choice between the two slices, two time units configuration; or the one slice, six time units configuration.

Looking at FIG. 7, Function 1 is implemented in block 70, Function 21 is implemented in block 72. Note that the selection of one slice, six-time units, even though it has more slice time units, actually works better to implement the Function than the two slices, two-time units. As shown in FIG. 7, Function 3 is implemented in block 74 rather than block 76.

The scheduler is preferably software that uses a resource and time indication to fit one of the two configurations into a resource schedule. Note that of the configuration examples shown in FIGS. 6 and 7 are rectangular in that all of the resources are used in each of the time units. This is not necessarily the case.

The scheduler considers issues about the efficiency of the entire system in order to operate. One way of managing the efficiency is to reduce the number of time units used up by a specific algorithm. By feeding the different configurations into different to the schedule, the system can more efficiently speed up the time of operation of the reconfigurable chip. Other issues involved with the scheduler include dependencies. If certain functions need to be finished before other functions are completed, naturally in some cases a faster configuration is selected, even opposed to a configuration which uses fewer resource time blocks.

It will be appreciated by those of ordinary skill in the art that the invention can be implemented in other specific forms without departing from the spirit or character thereof. The presently disclosed embodiments are therefore considered in all respects to be illustrative and not restrictive. The scope of the invention is illustrated by the appended claims rather than the foregoing description, and all changes that come within the meaning and range of equivalents thereof are intended to be embraced herein.

What is claimed is:

1. A method comprising:
providing multiple possible configurations for implementing a function on a reconfigurable chip, the configurations having different time and resource requirements;
in a scheduler, using the time and resource requirements of the configurations to select a configuration to implement a function in a reconfigurable chip; and
loading this configuration in the reconfigurable chip.

2. The method of claim 1 wherein the different configurations are stored in a library of configurations.

3. The method of claim 1 wherein the configuration is selected so as to speed up the total operation of an algorithm.

4. The method of claim 1 wherein the resources are slices.

5. The method of claim 1 wherein the indications of the time and resource requirements are stored for each configuration.

6. The method of claim 1 wherein the scheduler is a dynamic scheduler.

7. The method of claim 1 wherein the scheduler is a static scheduler.

8. The method of claim 1 wherein a schedule is used to determine the available time slots and resources for the reconfigurable chip.

9. The method of claim 1 wherein the scheduler examines the available resources and time slots in the schedule.

10. The method of claim 1 wherein the reconfigurable chip includes a reconfigurable fabric.

11. The method of claim 1 wherein the reconfigurable chip includes a number of slices.

12. The method of claim 1 wherein the reconfigurable chip includes a processor.

13. The method of claim 12 wherein the processor runs a dynamic scheduler.

14. A scheduler for a reconfigurable chip, the scheduler adapted to select a configuration from a group of more than one configurations, each of the configurations adapted to implement the same function on a reconfigurable chip, the configurations having different time and resource requirements, wherein the scheduler uses an indication of a schedule of available resources and the time and resource requirements of the configuration to select the configuration to be loaded on the reconfigurable chip.

15. The scheduler of claim 14 wherein the scheduler has access to a library containing the multiple configurations for the single function.

16. The scheduler of claim 14 wherein the scheduler speeds up the total operation of the reconfigurable chip.

17. The scheduler of claim 14 wherein the resources are slices on the reconfigurable chip.

18. The scheduler of claim 14 wherein the indications of the time and the resource requirements of the configurations are stored.

19. The scheduler of claim 14 wherein the scheduler is a dynamic scheduler.

20. The scheduler of claim 14 wherein the scheduler is a static scheduler.

21. The scheduler of claim 14 wherein the scheduler determines available time slots and resources from this schedule and examines the available resources and time slots

22. The scheduler of claim 14 wherein the scheduler is run as a dynamic scheduler on a processor of the reconfigurable chip.
